(19) United States
(12) Patent Application Publication
(10) Pub. No.: US 2022/0161827 A1
(43) Pub. Date: May 26, 2022

(54) METHOD AND DEVICE FOR TRANSFERRING A TELEOPERABLE VEHICLE FROM AN INITIAL OPERATING MODE TO A TARGET OPERATING MODE

(71) Applicant: Robert Bosch GmbH, Stuttgart (DE)

(72) Inventors: Alexander Geraldy, Hildesheim (DE); Behzad Benam, Leonberg (DE); Frederik Blank, Ludwigsburg (DE); Erik Walossek, Giesen (DE); Jan Wolter, Hannover (DE); Jens Schwardmann, Hildesheim (DE); Karl Theo Floess, Heilbronn (DE); Kurt Eckert, Ditzingen (DE)

(21) Appl. No.: 17/439,208

(22) PCT Filed: Jan. 23, 2020
(86) PCT No.: PCT/EP2020/051575

§ 371 Date: Sep. 14, 2021

(30) Foreign Application Priority Data
Apr. 5, 2019 (DE) 10 2019 204 942.7

(51) Int. Cl. B60W 60/00; B60W 40/08; G05D 1/00

(52) U.S. Cl. CPC B60W 60/0053; B60W 60/0059; B60W 60/0061; B60W 60/0015; G05D 2201/0213; G05D 1/0038; B60W 2040/0809; B60W 2556/40; B60W 40/08

(57) ABSTRACT

A method for transferring a teleoperable vehicle from an initial operating mode to a target operating mode. In the method, upon request, a handover of the driving responsibility to an intended operator is planned and prepared. Areas of the driving responsibility and operating limits of the vehicle in the target operating mode are negotiated. The negotiated operating limits are set. The handover is initiated and brought to a successful conclusion in the target operating mode.

### FIELD

The present invention relates to a method for transferring a teleoperable vehicle from an initial operating mode to a target operating mode. In addition, the present invention relates to a corresponding device, a corresponding computer program and a corresponding memory medium.

### BACKGROUND

Partially autonomous vehicles according to the related art require a vehicle control interface (driver workstation) as well as a person as a vehicle passenger who is capable of driving, has the authority to control the vehicle and may take over the control if necessary. So-called teleoperated driving (TOD) is a subject matter of numerous research projects and describes a situation in which the vehicle is supported by way of a remote control in handling challenging scenarios such as detours via dirt roads, alternative and unconventional routes or similar circumstances, or in which an external operator in a vehicle control center (VCC), the so-called operator, is able to assume the driving task in its entirety for certain periods of time. To this end, the vehicle and the control center or their operators are connected to each other by a mobile telephony network featuring a low latency and high data rate.

U.S. Pat. No. 9,494,935 B2 describes computer devices, systems and methods for the remote control of an autonomous passenger vehicle. When an autonomous vehicle is faced with an unexpected environment such as a road construction site or an obstacle that is not suitable for an autonomous operation, then the vehicle sensors are able to acquire data about the vehicle and the unexpected environment including images, radar and lidar data, etc. The acquired data can be transmitted to a remote operator. The remote operator is able to manually operate the vehicle in a remote manner or provide the autonomous vehicle with instructions that are to be executed by different vehicle systems. The acquired data transmitted to the remote operator are able to be optimized in order to save bandwidth, for instance in that a limited partial quantity of the acquired data is transmitted.

A vehicle according to the U.S. Pat. No. 9,767,369 B2 can receive one or more image(s) of an environment of the vehicle. The vehicle may also receive a map of the environment. In addition, the vehicle is able to compare at least one feature in the images to one or more feature(s) in the map. In addition, the vehicle is also capable of identifying a certain region in the one or the plurality of images which corresponds to a part of the map and is located within a threshold distance from the one or the plurality of features. Also, the vehicle can compress the one or the plurality of images in order to record a lower number of details in regions of the images as the given region. The vehicle is also capable of providing the compressed images to a remote system and of receiving operating instructions from the remote system in response.

Systems and methods according to the U.S. Pat. No. 9,465,388 B1 enable an autonomous vehicle to request assistance from a remote operator when the trust of the vehicle in the operation is low. An exemplary method includes the operation of an autonomous vehicle in a first autonomous mode. The method may also include the identification of a situation in which a trust level of an autonomous operation in the first autonomous mode lies under a threshold value. Furthermore, the method may also include the transmission of a request for assistance to a remote assistant, the request including sensor data that represent a section of an environment of the autonomous vehicle. The method may additionally include the receiving of a response from the remote assistant, the response indicating a second autonomous operating mode. The method may also induce an operation of the autonomous vehicle in the second autonomous operating mode in accordance with the response by the remote assistant.

U.S. Pat. No. 9,720,410 B2 describes a further method for remote assistance for autonomous vehicles in predefined situations.

### SUMMARY

The present invention provides a method for transferring a teleoperable vehicle from an initial operating mode to a target operating mode, a corresponding device, a corresponding computer program and a corresponding memory medium.

One advantage of an example embodiment of the present invention lies in the safe handover (handover) of the control of a partially or fully automated vehicle between the vehicle and control center while taking operating modes, an environment situation, the function scope, compatibility and the state of the vehicle into account.

A handover of the control may be necessary when a loss of control and an attendant danger is able to be anticipated in the current operating mode. One embodiment of the present invention ensures that no safety targets are disregarded during and also immediately following such a control handover. To this end, current and expectable states of the vehicle, the environment, communication and control center are compared to safety targets and used as the basis of a handover decision and handover strategy.

The measures described herein allow for advantageous further developments and improvements of the basic features of the present invention. For example, it may be provided that, prior to a possible initiation of the handover, the requirements of the target operating mode are determined and functions as well as the compatibility of the vehicle are aligned. This allows for a defined responsibility distribution so that safety risks are minimized and an acceptable residual risk is achieved.

### BRIEF DESCRIPTION OF THE DRAWINGS

Exemplary embodiments of the present invention are shown in the figures and described in greater detail below.

FIG. 1 shows different actors and entities relevant within the scope of the present method.

FIG. 2 shows the flow diagram of the present method according to one example embodiment of the present invention.

### DETAILED DESCRIPTION OF EXAMPLE EMBODIMENTS

Typically, the responsibility for the control of a vehicle and its type depend on the operating mode of the vehicle. The present embodiment is based on a partially automated or automated vehicle of the autonomy levels 2 through 5 according to SAE J3016, which presupposes a certain minimum number of sensors and actuators.

### Examples of Operating Modes are:

The vehicle has—at least in a plannable region—full control of its driving functions (high or full automation of level 4 and level 5, respectively).
A passenger, in particular the driver, is supported in carrying out the driving functions (partial automation or conditional automation according to level 2 and 3, respectively).
An operator in the VCC without a direct line of sight directly or indirectly controls the actuators of the vehicle using a wireless network based on vehicle and environment information, which is received with the aid of sensors of the vehicle for the most part.
An operator in the direct environment of the vehicle controls the vehicle by sight. The optional use of existing sensor equipment is possible but not required.
In specified areas, the vehicle is controlled with the aid of existing environment sensor systems by an available infrastructure, for instance in a parking facility equipped accordingly.
The vehicle is part of a vehicle convoy and is co-controlled by the vehicles driving ahead (platooning).
A service vehicle automatically follows a person or another vehicle in order to carry out safeguarding tasks, for transport purposes or in order to perform other tasks.
The vehicle follows gestures in order to be guided by a person.

A transition between such operating modes may be indicated for a variety of reasons:
The current operating mode may not be safely maintained in the foreseeable future, for instance due to the state of health of the driver or limits of the operating mode. A handover is absolutely necessary for safety-related reasons.
A handover from one mode to another is scheduled, for instance when leaving a parking facility and then driving on public roads.
Comfort-related reasons suggest a handover, for instance when the current driver of the vehicle would like to relax or work.
Resource planning seems to make the handover desirable, for instance when the operator is available only for a limited period of time.

In addition, the following triggers for a handover are possible:
A spontaneous or anticipated detection of a safety problem with the current operating mode,
Scheduling of a handover due to the known driving destination and suitable strategies for comfort and a cost reduction, or
A manual request by the driver, operator or some other actor.

In this context, the following initiators of the handover have to be considered:
the vehicle driver responsible in the current operating mode,
the vehicle driver responsible in the scheduled subsequent mode, or
a third party which believes to identify the need for a mode change.

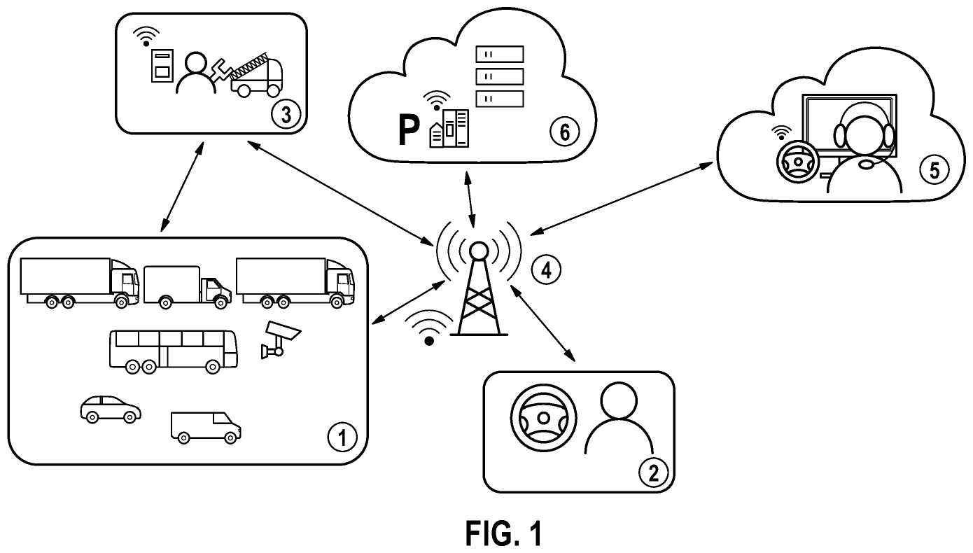

Directly involved actors and entities are (see FIG. 1)
a partially automated vehicle (1) that also allows for a remote operation,
a driver or other passengers (2) possessing a driver's license, who assume(s) the direct control of the vehicle,
police, rescue personnel or towing services (3), which assume the remote operation of the vehicle in the event of an emergency either via a mobile telephony network (4) or a direct wireless communication,
a wireless local computer network (wireless local area network, WLAN) or a mobile telephony network (4) that allows for a remote operation,
a VCC (5) as a working location of the operator, or
an infrastructure (6), which monitors the vehicle (1) and controls it automatically within limited areas.

In the following text, a “handover” generally denotes a change from one operating mode to another mode. This change should ideally take place in moving traffic while driving in order to provide the greatest benefit possible. If this is not feasible or useful, then a handover at a reduced speed or at a standstill is to be carried out.

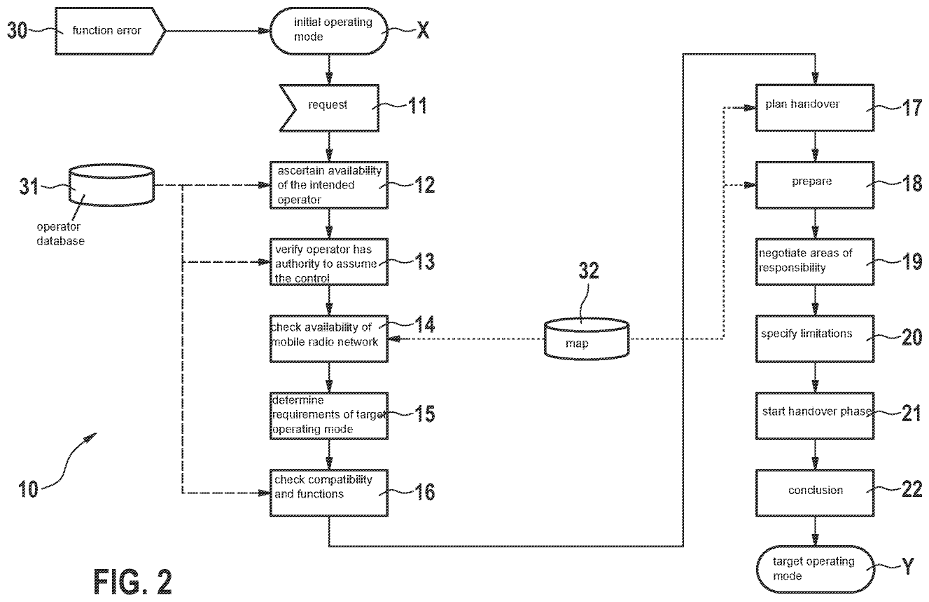

The handover takes place according to a generic sequence, which may be gathered from FIG. 2 and is specialized depending on the target operating mode (Y). The sequence starts in the initial operating mode (X) in response to a corresponding request (11). The sequence of the following steps is variable. As soon as a check step or preparatory step has not been carried out successfully or a time exceedance (timeout) occurs, the handover is aborted and the vehicle (1) remains in the initial operating mode (X).

Next, a check to ascertain the availability of the intended operator (12) takes place. It then has to be verified that said operator has the authority to assume (13) the control. Among other things, this step includes a check of the communications reliability in accordance with recognized IT security guidelines, for instance using a public key infrastructure (6) (PKI) and—depending on the target operating mode (Y)—the verification that a driver's license or a TOD license exists.

Next, an availability check (14) of the mobile radio network (4) on the scheduled driving route, a determination (15) of the requirements of the target operating mode (Y) and the intended operator, and a check (16) of the compatibility and functions (features) of the vehicle (1) take place. The latter includes a reconciliation of technical requirements with regard to sensors and actuators and a check for technical defects that could pose a risk to a handover.

After a successful conclusion of these checks, the handover is planned in terms of type, time and location (17) and prepared (18) and the areas of responsibility are negotiated (19) and corresponding limitations are specified (20). In the latter step, for instance, it has to be determined whether vehicle systems are to be utilized alternatively or are to be overridden or whether there are limits that are to be fixedly configured such as with regard to the speed, acceleration or distances.

Finally, the handover phase can be started (21). Upon a successful conclusion (22) of the handover, the current operator is informed and relieved from responsibility for the vehicle (1). As a consequence, the vehicle (1) is in the target operating mode (Y).

Depending on the source and target modes, different embodiments are possible without departing from the framework of the present invention.

If a passenger is located inside the vehicle (1) who would be able to safely control the vehicle (1) according to the law, then this may be scheduled as a fallback solution in the event of an interruption of the TOD. This allows for a TOD also on routes that do not allow for a reliable and uninterrupted remote control.

In this scenario, the passengers (2) may be given the option of intervening in the control after first checking their authority (13), for instance by overriding or with the aid of an emergency stop switch.

As soon as a person controls the vehicle (1), monitoring with the aid of what is known as a dead-man switch, for instance, may be used in order to initiate the handover as soon as there are signs that the control of the vehicle (1) may be unreliable. Evaluation functions, automatically or manually defined by users, are able to be utilized for selecting suitable operators that offer the greatest possible comfort.

If a vehicle (1) is to be given over to an infrastructure-based control (6), e.g., a parking facility, it is helpful if the vehicle (1) is parked in a dedicated spot and is taken over while at a standstill. This not only allows the passengers (2) to disembark without hindrance but also the transfer to a safe state. Resource problems and critical states as they may occur when the vehicle is in motion are avoided in this way. The location of the handover should be selected so that the possibly involved mobile radio network (4) offers sufficient coverage at that location.

In every handover it has to be ensured that the mode or the operator taking over is authorized for the individual vehicle type, the specific vehicle (1) and its destinations. This check (13) is able to be performed on the basis of a driver's license of the driver (2) in the vehicle (1) or of the operator in the VCC (5) or within a visual range of the vehicle (1). Also taken into account is a comparison with the vehicle environment (private property with or without the presence of persons, a location within city limits, a superhighway, a road reserved for automated vehicles, etc.) or possible authorization limitations by the manufacturer, fleet manager and owner.

Possible in addition is the control of the vehicle (1) by employees of rescue services, the police or towing services (3) located within the visual range. If a mobile radio connection is available, then the corresponding mode change should be centrally checked and recorded. However, a direct control of the vehicle (1) by authorized services (3) is possible as well, for instance if the vehicle is located in a dead spot without reception. To this end, cryptographic mechanisms have to be used on the part of the vehicle (1) and the control of the rescue personnel (3), which allow for a control only by authorized personnel (3) also without a mobile radio network (4).

For instance, this method (10) is able to be implemented in software or hardware or in a mixed form of software and hardware, e.g., in a control unit of the vehicle (1).

The following numbered Examples describe various example embodiments of the present invention.

Example 1. A method for transferring a teleoperable vehicle (1) from an initial operating mode (X) to a target operating mode (Y),

characterized by the following features:
upon request (11), a handover of the driving responsibility to an intended operator is planned (17) and prepared (18) in the initial operating mode (X),
areas of the driving responsibility and operating limits of the vehicle (1) in the target operating mode (Y) are negotiated (19),
the negotiated operating limits are set (20), and
the handover is initiated (21) and brought to a safe conclusion (22) in the target operating mode (Y).

Example 2. The method (10) as recited in Example 1,

characterized by the following feature:
prior to the initiation (21) of the handover, it is checked whether the operator is available (12).

Example 3. The method (10) as recited in Example 2,

characterized by the following feature:
prior to the initiation (21) of the handover, it is checked whether the operator is authorized to control (13) the vehicle (1) via a mobile telephony network (4).

Example 4. The method (10) as recited in Example 3,

characterized by the following feature:
prior to the initiation (21) of the handover, a map (32) is used to calculate whether the mobile telephony network (4) is available (14) following the planned (17) handover.

Example 5. The method (10) as recited in Example 3 or 4,

characterized by the following features:
prior to the initiation (21) of the handover, requirements of the target operating mode (Y) are determined (15), and
functions and the compatibility of the vehicle (1) are compared (16) with the requirements.

Example 6. The method (10) as recited in Example 5,

characterized by the following feature:
checking (12, 13) and comparing (16) the functions and compatibility is performed based on an operator database (31).

Example 7. The method (10) as recited in one of Examples 1 through 6,

characterized by the following feature:
in the event of a function error (30) during the method (10), the handover will be aborted and the initial operating mode (X) be maintained.

Example 8. A computer program which is set up to carry out the method (10) as recited in one of Examples 1 through 7.

Example 9. A machine-readable memory medium on which the computer program as recited in Example 8 is stored.

Example 10. A device (1, 4, 5, 6) which is set up to carry out the method as recited in one of Examples 1 through 7.

1-10. (canceled)

11. A method for transferring a teleoperable vehicle from an initial operating mode to a target operating mode, the method comprising the following steps:
planning and preparing, upon request, a handover of the driving responsibility to an intended operator in the initial operating mode;
negotiating areas of the driving responsibility and operating limits of the vehicle in the target operating mode;
setting the negotiated operating limits; and
initiating the handover and bringing the handover to a safe conclusion in the target operating mode.

12. The method as recited in claim 11, further comprising:
prior to the initiation of the handover, checking whether the operator is available.

13. The method as recited in claim 12, further comprising:
prior to the initiation of the handover, checking whether the operator is authorized to control the vehicle via a mobile telephony network.

14. The method as recited in claim 13, further comprising:
prior to the initiation of the handover, using a map to calculate whether the mobile telephony network is available following the planned handover.

15. The method as recited in claim 13, further comprising:
prior to the initiation of the handover, determining requirements of the target operating mode; and
comparing functions and a compatibility of the vehicle with the requirements.

16. The method as recited in claim 15, wherein the checking and the comparing of the functions and compatibility is performed based on an operator database.

17. The method as recited in claim 11, wherein, in the event of a function error during the method, the handover is aborted and the initial operating mode is maintained.

18. A non-transitory machine-readable memory medium on which is stored a computer program for transferring a teleoperable vehicle from an initial operating mode to a target operating mode, the computer program, when executed by a computer, causing the computer to perform the following steps:
planning and preparing, upon request, a handover of the driving responsibility to an intended operator in the initial operating mode;
negotiating areas of the driving responsibility and operating limits of the vehicle in the target operating mode;
setting the negotiated operating limits; and
initiating the handover and bringing the handover to a safe conclusion in the target operating mode.

19. A device configured for transferring a teleoperable vehicle from an initial operating mode to a target operating mode, the device configured to:
plan and prepare, upon request, a handover of the driving responsibility to an intended operator in the initial operating mode;
negotiate areas of the driving responsibility and operating limits of the vehicle in the target operating mode;
set the negotiated operating limits; and
initiate the handover and bringing the handover to a safe conclusion in the target operating mode.
